(19) United States
(12) Patent Application Publication
(10) Pub. No.: US 2003/0210920 A1
(43) Pub. Date: Nov. 13, 2003

(54) Image formation apparatus and image formation method

(76) Inventor: Masato Kuga, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/392,863

(22) Filed: Mar. 21, 2003

(30) Foreign Application Priority Data
Mar. 22, 2002 (JP) 2002-82011

(51) Int. Cl. G03G 15/00

(52) U.S. Cl. 399/82

(57) ABSTRACT

An image formation apparatus is provided with an image state detector that detects the property of image data, a determining section that determines, based on the property of image data detected by the image state detector, as to whether the image of the image data is to be formed by its own apparatus or another image formation apparatus on a network, an image formation section that forms an image for an image output from the image data when the determining section determines that the image is to be formed by its own apparatus, and a transmission processor that transmits the image data to the other image formation apparatus when the determining section determines that the image is to be formed by the other image formation apparatus.

### BACKGROUND OF THE INVENTION

1) Field of the Invention

The present invention relates to an image formation apparatus and an image formation method capable of achieving load distribution by the use of another image formation apparatus connected to a network.

2) Description of the Related Art

Conventionally, there is an image formation apparatus such as a copying apparatus, configured as, for example, a connected copying system in which the image formation apparatus is connected to another image formation apparatus via a network.

One example of such a connected copying system is configured such that a plurality of image formation apparatuses are connected to each other via a network (i.e., communication means) such as a LAN, where a printing mode is set and an original is scanned in a predetermined one of the image formation apparatuses, and stored data is transferred to another image formation apparatus to allow the another image formation apparatus to print out the data.

The greatest feature of this system resides in that a printing time can be shortened by allocating the data to the image formation apparatuses, or that a printing operation can be implemented by another machine on the system by transferring the data to that machine even when a certain machine is not in an operative state, for example, in the state in which a trouble such as paper jamming occurs in the machine or sheets are being replenished, thereby reducing a downtime as the entire system.

As an example of conventional technology similar in technical field to the present invention, Japanese Patent Application Laid-Open No. 9-27876 and other numerous inventions are proposed.

An object of “copying system” disclosed in Japanese Patent Application Laid-Open No. 9-27876 as the conventional technology is to provide a copying system capable of efficiently recovering copying in order to recover the number of output sheets by another copying machine, when one of copying machines cannot form an image caused by paper jamming or the like during image outputting.

However, in the conventional system, consideration is given to only a trouble such as paper jamming or paper replenishment by which the printing operation by the machine is completely stopped. That is, control cannot be exerted over such operation that a job capable of printing is allowed to be executed according to an image printing mode even in a state of waiting for partial replenishment of consumables, such a state being frequently observed in an image formation apparatus capable of color image formation.

### SUMMARY OF THE INVENTION

The present invention has been achieved in order to solve the above problems. It is an object of the present invention to provide an image formation apparatus capable of performing an operation control according to a type of temporary or permanent trouble in image printing to achieve load distribution of image formation processing.

The image formation apparatus according to one aspect of this invention, comprises an image state detecting unit that detects a property of image data, and a determining unit that determines whether the image data is to be formed by its own apparatus or another image formation apparatus on a network based oh the property of the image data detected by the image state detecting unit. The image formation apparatus also comprises an image forming unit that forms an image to be output from the image data when the determining unit determines that the image is to be formed by its own apparatus, and a transmitting unit that transmits the image data to the another image formation apparatus when the determining unit determines that the image is to be formed by the another image formation apparatus.

The image formation method according to another aspect of this invention, comprises the steps of detecting a property of image data, and determining whether the image data is to be formed by its own apparatus or another image formation apparatus on a network, based on the property of the image data detected at the step of detecting the property. The image formation method also comprises the steps of forming an image to be output from the image data when it is determined at the determining step that the image is to be formed by its own apparatus, and transmitting the image data to the another image formation apparatus when it is determined at the determining step that the image is to be formed by the another image formation apparatus.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 shows a diagram of the configuration of a network of a connected copying system including image copying apparatuses in a first embodiment of the present invention;

FIG. 2 is a block diagram of the functional configuration of the image copying apparatus in the first embodiment;

FIG. 3 shows a diagram of a system in which the property of an image of an original is determined to perform load distribution of image formation processing;

FIG. 4 is a flowchart of procedures of image formation processing and printing processing by a master machine A;

FIG. 5 is a flowchart of procedure of printing processing by a slave machine B;

FIG. 6 shows a diagram of one example of a system setting screen; and

FIG. 7 is a flowchart of procedures of image formation processing and printing processing by a master machine A in a second embodiment.

### DETAILED DESCRIPTIONS

Embodiments of the image formation apparatus and the image formation method according to the present invention are explained in detail below with reference to the accompanying drawings. In the embodiments, the image formation apparatus according to the present invention is applied to a copying apparatus. Incidentally, in addition to the copying apparatus, the present invention can be applied to a printer apparatus or a multifunction machine in which the respective functions of a printer, a copier, a facsimile, a scanner, and the like are incorporated inside of a single casing.

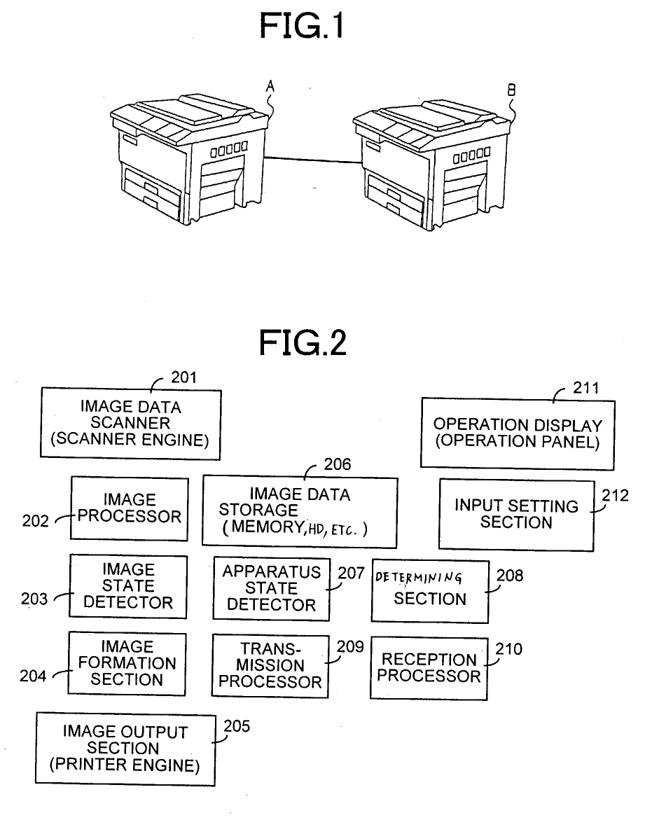

FIGS. 1 to 5 show an image copying apparatus in a first embodiment. FIG. 1 shows a diagram of the configuration of a network of a connected copying system including image copying apparatuses in the first embodiment of the present invention. As shown in FIG. 1, the connected copying system in the present embodiment is configured such that two image copying apparatuses are connected to each other via a network (i.e., communication means) such as a LAN. The image copying apparatuses are constituted of a master machine A and a slave machine B.

In the conventional system, for example, it is general that when a toner of any color among toners of four colors concerned in forming an image is used up in a certain machine A, replenishment of the toner is waited in the machine A or another machine B fully supplied with the toners of the four colors is searched so that a printing operation is performed in the machine B.

In any case, the downtime of the machine A cannot be avoided, or even when it could be avoided, the printing operation is merely performed by the machine B in place of the machine A. Therefore, the printing operation still remains inefficient as the entire system.

The present invention notes the matter in which even when a toner of an image formation color is used up (i.e., empty) in a certain copying apparatus that receives a printing request when connection copying or connection printing is performed by connecting a plurality of copying apparatuses, a printing operation can be achieved in another copying apparatus when the toner of the image formation color remains in that connected copying apparatus.

An intention according to the present invention is to remarkably enhance efficiency by, when an image of an original that can be printed with toners of other image formation colors is contained in the received original image data even when a toner of a certain image formation color is used up in the machine A, allocating the formation of that image to the machine A while the other image formation to the machine B.

The present invention as one aspect is provided to enhance the operating efficiency of the system even when the toner of the image formation color is used up (i.e., empty) in a certain copying machine that receives the printing request, the printing operation can be achieved in the other copying machine when the toner of the image formation color remains in that connected copying machine, thereby printing the scanned image by allocating them to the machines capable of forming the images.

The present invention as another aspect is provided to allow a service engineer or a user to judge in selecting whether the function is made valid or invalid.

The present invention as still another aspect is provided so as to take operation into consideration by giving priority to obtaining a print result desired by a user without the load distribution when a sort mode or a staple mode is set.

For easy understanding in a description below, the case in which two color copying machines are tandem-connected to each other so as to perform copying or printing is explained as one example. Then, A denotes a master machine, and B denotes a slave machine.

FIG. 2 is a block diagram of the functional configuration of the image copying apparatus in the first embodiment. Each of the master machine A and the slave machine B has the same configuration. Here, only the master machine A may adopt the configuration shown in FIG. 2 while the slave machine B may have the configuration of the conventional image copying apparatus.

As shown in FIG. 2, the image copying apparatus in the present embodiment comprises an image data scanner 201, an image processor 202, an image state detector 203, an image formation section 204, an image output section (i.e., a printer engine) 205, an image data storage 206, an apparatus state detector 207, a determining section 208, a transmission processor 209, a reception processor 210, an operation display 211 and an input setting section 212.

The image data scanner 201 is a scanner engine for scanning an original. The image processor 202 converts the image of the original scanned by the image data scanner 201 into image data such as bitmap data or performs other image processing.

The image data storage 206 is adapted to temporarily store various kinds of image data therein, and corresponds to a memory or a hard disk (abbreviated as “an HD”).

The image state detector 203 detects the property of the image data, that is, as to whether the original is color or monochrome based on the image data of the original.

The apparatus state detector 207 detects a toner type and the residual toner amount for each toner type in the image copying apparatus. This apparatus state detector 207 transmits a detection request for a toner type and the residual toner amount for each toner type in the other image copying apparatus (i.e., the slave machine B) on the network, and receives the detection result.

The determining section 208 determines, based on the property of the image data detected by the image state detector 203 and the toner type and the toner residual amount detected by the apparatus state detector 207, as to whether the image data is printed by the master machine A or the slave machine B on the network.

The image formation section 204 is adapted to convert the image data into data in a printing format. The image output section 205 is a printer engine for printing and outputting the data in the printing format converted by the image formation section 204.

The transmission processor 209 transmits the image data to the other image copying apparatus on the network when the determining section 208 determines that the image of the image data is formed and printed by not its own apparatus but the other image copying apparatus. The reception processor 210 receives the image data from the other image copying apparatus on the network.

The operation display 211 is an operation panel, which inputs the setting of determination of load distribution as to whether the image of the image data is to be formed and printed by its own apparatus or the other image copying apparatus on the network, or inputs the setting of a printing mode such as a staple mode or a sort mode.

The input setting section 212 is adapted to store, in a storage unit such as a memory, the data displayed on a display or input/set with respect to the operation display 211.

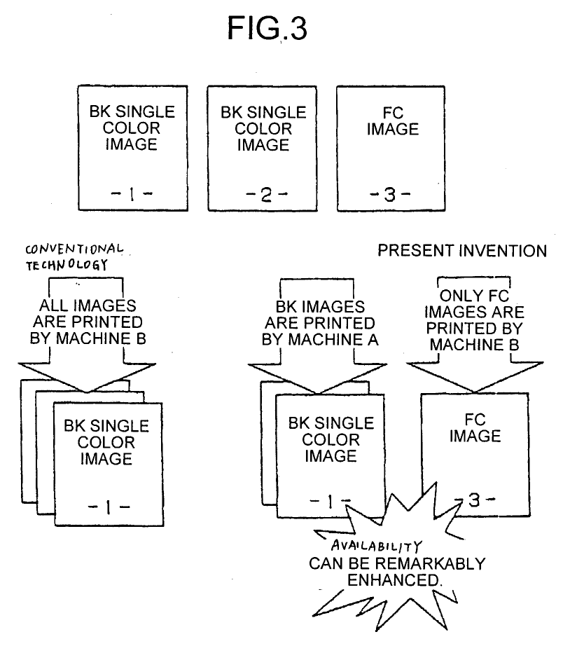

Subsequently, image formation processing and printing processing by the image copying apparatus in the present embodiment such configured as described above is explained. FIG. 3 shows a diagram in which the property of the image of the original is determined to perform load distribution of image formation processing. For example, conventionally, both of a BK single image (i.e., a monochrome image) and an FC image (i.e., a full color image) is printed by the machine B. However, according to the present invention, the image of the image data of BK (i.e., the monochrome image) is printed by the machine A while only the image of the image data of FC (i.e., the full color image) is printed by the machine B. That is to say, the printing operation is distributed to the machines A and B.

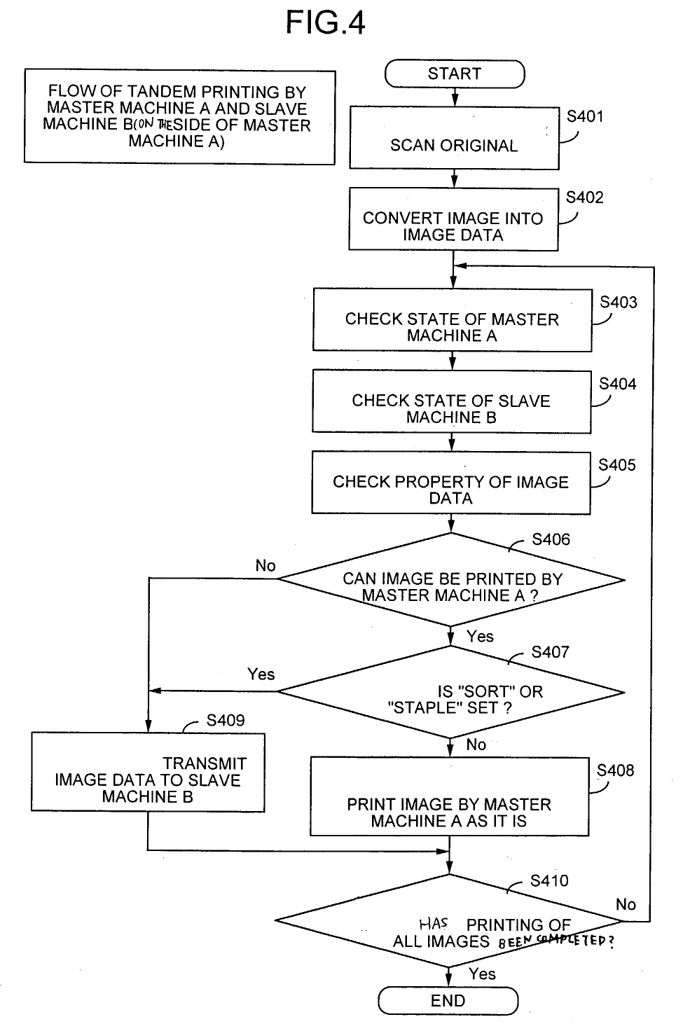

FIG. 4 is a flowchart of the procedures of the image formation processing and printing processing by the master machine A. Here, assume that the original consists of a plurality of pages that have monochrome images and color images.

First, the image data scanner 201 scans the original (step S401). Thereafter, the image processor 202 converts the scanned image into the image data in a bitmap format or the like, and then, stores it into the image data storage 206 (step S402).

Next, the apparatus state detector 207 checks the state of its own machine (i.e., the master machine A) (step S403). Specifically, the apparatus state detector 207 detects the toner type and the toner residual amount of each toner type. Thereafter, the apparatus state detector 207 checks the state of the slave machine B on the network, that is, detects the toner type and the toner residual amount of each toner type (step S404).

Subsequently, the image state detector 203 scans the image data stored in the image data storage 206, and then, determines the property of the image data, that is, as to whether the image data is color or monochrome (step S405). And then, the determining section 208 determines as to whether the image data can be printed by its own machine (i.e., the master machine A) (step S406). Consequently, the image data on pages of the original, which can be formed and printed by the master machine A, can be selected. The original has monochromatic images and color images.

The determination as to whether the image can be printed is specifically carried out as follows, for example, when it is determined at step S403 that the toner type in its own machine (i.e., the master machine A) is only a black toner, that the black toner is not empty, and further, that it is determined at step S405 that the image data is monochrome, it is determined that the image of the image data can be printed by its own machine (i.e., the master machine A).

Moreover, when it is determined at step S403 that the toner type in its own machine (i.e., the master machine A) is toners of a plurality of image formation colors, that all of the toners remain, and further, determined at step S405 that the image data is color or monochrome, it is determined that the image of the image data can be printed by its own machine (i.e., the master machine A).

In contrast, when it is determined at step S403 that the toner type in its own machine (i.e., the master machine A) is only a black toner, that the black toner is not empty, and further, determined at step S405 that the image data is color, it is determined that the image of the image data cannot be printed by its own machine (i.e., the master machine A). Moreover, also when it is determined at step S403 that the toner type in its own machine (i.e., the master machine A) is only a black toner, and further, that the black toner is empty, it is determined that the image of the image data cannot be printed by its own machine (i.e., the master machine A).

When it is determined at step S403 that the toner type in its own machine (i.e., the master machine A) is toners of a plurality of image formation colors, that the toner of any one of the image formation colors is empty, and further, determined at step S405 that the image data is color, it is determined that the image of the image data cannot be printed by its own machine (i.e., the master machine A).

When it is determined that the image of the image data cannot be printed, the transmission processor 209 transmits the image data to the slave machine B when it is determined at step S404 that the toner type in the slave machine B is the toners of the image formation colors and all of the toners remain (step S409).

In contrast, when it is determined at step S406 that the image of the image data can be printed, the determining section 208 reads the printing mode setting stored in the memory or the like, and then, determines as to whether a “sort” mode or a “staple” mode is set (step S407). When the “sort” mode or the “staple” mode is set, the transmission processor 209 transmits all of the image data from the master machine A to the slave machine B since it's nonsense to print the individual originals by the two machines. In contrast, when the “sort” mode or the “staple” mode is not set, the image formation section 204 converts the data into the printing format and the image output section 205 performs the printing such that the slave machine A performs the printing (step S408).

The processing from step S403 to step S409 as described above is repeated with respect to the images of all of the originals (step S410).

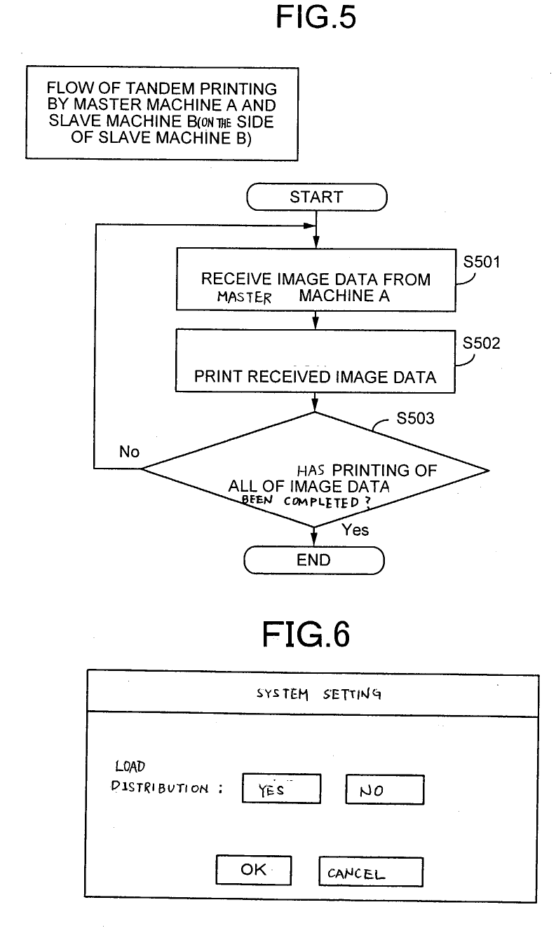

Subsequently, printing processing by the slave machine B that receives the image data from the master machine A is explained. FIG. 5 is a flowchart of procedure of the printing processing by the slave machine B.

In the slave machine B, the reception processor 210 receives the image data from the master machine A (step S501). The image formation section 204 converts the data into the printing format and the image output section 205 performs the printing so as to print the received image data (step S502). In order to print all of the image data transmitted from the master machine A, the processing at steps S501 and S502 is repeated (step S503).

In this manner, in the image copying apparatus in the first embodiment, the property of the image data is detected, it is determined as to whether the image of the image data is formed by its own apparatus or by the other image formation apparatus on the network based on the detected property of the image data, and the image formation for the image output from the image data is performed when it is determined that the image of the image data is to be formed by its own apparatus, in contrast, the image data is transmitted to the other image formation apparatus when it is determined that the image is to be formed by the other image formation apparatus. Thus, it is possible to perform the operation control according to the type of image printing trouble that is temporary or permanent, so as to achieve the load distribution of the image formation processing.

In other words, it is possible to suppress the deterioration of the system operating efficiency, unlike the conventional technology in which the printing can be performed only by the copying machine in which no toner is empty even when the toner of only one of the image formation colors becomes empty even when the connected copying system is configured. Furthermore, since the printing result is influenced by the load distribution when the sort mode or the staple mode is set, the operation can be achieved in such a manner as to obtain the printing result desired by a user.

Incidentally, although in the image copying apparatus in the first embodiment, the determining section 208 determines as to whether the toner is empty, the image copying apparatus may be configured such that it is determined that the image formation and the printing cannot be achieved when the toner residual amount is smaller than a predetermined value.

Although in the image copying apparatus in the first embodiment, the printing modes determined by the determining section 208 are limited to the sort mode and the staple mode, the image copying apparatus may be configured such that it is determined as to whether another printing mode such as a duplex mode is set.

An image copying apparatus in a second embodiment is configured such that a user can designate determination as to whether an image of image data to be formed by its own apparatus or by another image copying apparatus on a network. The functional configuration of the image copying apparatus in the first embodiment is the same as that of the image copying apparatus in the first embodiment.

In the image copying apparatus in the second embodiment, a system setting screen is displayed on an operation display 211 by an input setting section 212. FIG. 6 is an explanatory diagram of one example of the system setting screen. As shown in FIG. 6, “Yes” or “No” as items of load distribution can be set on the system setting screen.

When “Yes” of the load distribution is set, a determining section 208 determines the load distribution as to whether an image of image data is to be formed by its own apparatus or by another image copying apparatus on a network. When a master machine A cannot form and print the image, the image data is transmitted to a slave machine B.

In contrast, when “No” of the load distribution is set, the master machine A can form and print the images of all of the image data without any processing of the determination of the load distribution.

When the user inputs “Yes” of the load distribution on the screen shown in FIG. 6, the input setting section 212 stores data of “designation of load distribution” in a memory or the like. In contrast, when the user inputs “No” of the load distribution, the input setting section 212 stores data of “no designation of load distribution” in the memory or the like.

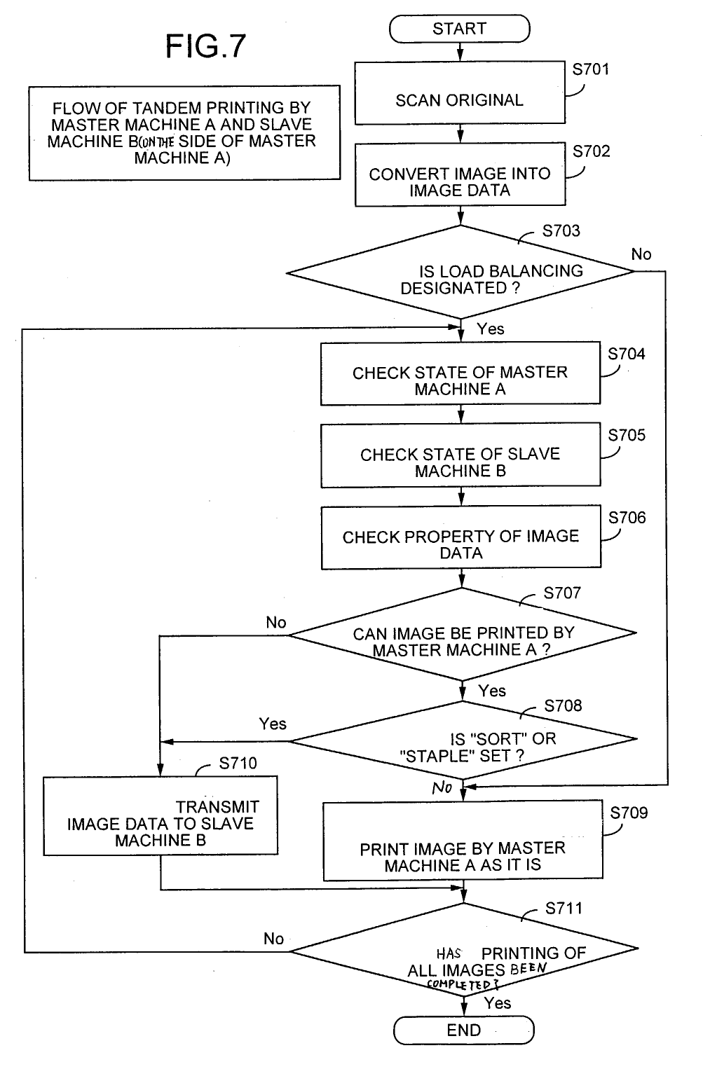

FIG. 7 is a flowchart of procedures of image formation processing and printing processing by the master machine A in the second embodiment.

In the same manner as in the first embodiment, an image data scanner 201 scans an original (step S701). Thereafter, an image processor 202 converts the scanned image into the image data in a bitmap format or the like, and then, stores it into an image data storage 206 (step S702).

Subsequently, the determining section 208 reads the data designating the load distribution, stored in the memory or the like, and then, determines as to whether the load distribution is designated (step S703). As a result, when the load distribution is designated, the determining section 208 determines as to whether the image of the image data is to be formed by its own apparatus or by the other image copying apparatus on the network, and then, outputs the image data in the same manner as in the first embodiment (steps S704 to S710).

In contrast, unless the load distribution is designated, the master machine A forms and prints the images of all of the image data by the master machine A (step S709).

In this manner, in the image copying apparatus in the second embodiment, the determination of the load distribution is set as to whether the image of the image data is to be formed by its own apparatus or by the other image formation apparatus on the network. When the determination of the load distribution is set to be carried out, it is determined, based on the property of the detected image data and the detected state of the apparatus, as to whether the image of the image data is to be formed by its own apparatus or by the other image formation apparatus on the network. Consequently, when the availability of the output results together by the single apparatus is desired more than the system operating efficiency, a service engineer or a user can judge in selecting as to whether the load distribution is valid or invalid, and therefore, he or she can flexibly cope with the load distribution.

As described above, according to one aspect of this invention, it is advantageously possible to perform the operation control in accordance with the type of image printing trouble that is temporary or permanent to achieve the load distribution of the image formation processing.

Moreover, it is advantageously possible to determine whether the image of the image data is to be formed by its own apparatus according to the state of the apparatus and carry out the load distribution of the image formation processing.

Furthermore, it is advantageously possible to determine whether the image is to be formed by another specific image formation apparatus on the network and securely carry out the load distribution of the image formation processing.

Moreover, it is advantageously possible to securely output the color image by an appropriate image formation apparatus.

Furthermore, it is advantageously possible to avoid any impossibility of outputting the image data caused by the shortage of the toner.

Moreover, it is advantageously possible to output all of the images of the pages by an appropriate image formation apparatus.

Furthermore, it is advantageously possible to distribute the output of the image data to its own apparatus and another image formation apparatus so as to avoid the meaningless mode setting.

Moreover, it is advantageously possible to distribute the output of the image data to its own apparatus and another image formation apparatus so as to avoid the meaningless mode setting per set of sheets.

Furthermore, it is advantageously possible to select whether the load distribution is valid or invalid based on the determination by the service engineer or the user when collective reception of the output results is desired through the single apparatus rather than higher system operating efficiency and flexibly cope with the load distribution.

The present document incorporates by reference the entire contents of Japanese priority document, 2002-082011 filed in Japan on Mar. 22, 2002.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image formation apparatus comprising:
an image state detecting unit that detects a property of image data;
a determining unit that determines whether an image of the image data is to be formed by its own apparatus or another image formation apparatus on a network based on the property of the image data detected by the image state detecting unit;
an image forming unit that forms an image to be output from the image data, when the determining unit determines that the image is to be formed by its own apparatus; and
a transmitting unit that transmits the image data to the another image formation apparatus when the determining unit determines that the image is to be formed by the another image formation apparatus.

2. The image formation apparatus according to claim 1, further comprising an apparatus state detecting unit that detects a state of the image formation apparatus,
wherein the determining unit determines whether an image of the image data is to be formed by its own apparatus or the another image formation apparatus on the network based on the detected property of the image data and the state of the image formation apparatus detected by the apparatus state detecting unit.

3. The image formation apparatus according to claim 2,
wherein the apparatus state detecting unit detects a state of the another image formation apparatus connected to the network.

4. The image formation apparatus according to claim 1,
wherein the apparatus state detecting unit detects whether the image data is monochrome data or color data, and
the determining unit determines that an image of the image data is to be formed by the another image formation apparatus on the network, when the detected property of the image data is color and its own apparatus is designed specifically for the monochrome data.

5. The image formation apparatus according to claim 2,
wherein the apparatus state detecting unit is adapted to detect a residual amount of toner, and
the determining unit determines that an image of the image data is to be formed by the another image formation apparatus on the network, when the residual amount of toner detected by the apparatus state detecting unit is smaller than a predetermined value.

6. The image formation apparatus according to claim 2,
wherein the determining unit determines, for each of pages of the image data, whether an image of the image data is to be formed by its own apparatus or the another image formation apparatus on the network based on the detected property of the image data and the state of the apparatus detected by the apparatus state detecting unit,
the image forming unit forms an image to be output from the image data with respect to the page determined to be formed by its own apparatus by the determining unit, and
the transmitting unit transmits image data for the page determined to be formed by the another image formation apparatus by the determining unit, to the another image formation apparatus.

7. The image formation apparatus according to claim 6,
wherein the determining unit determines, with respect to all of the pages of the image data, whether an image of the image data is to be formed by its own apparatus or the another image formation apparatus on the network when a predetermined setting is carried out with respect to the image formation of the image data.

8. The image formation apparatus according to claim 7,
wherein the determining unit determines, with respect to all of the pages of the image data, whether an image of the image data is to be formed by its own apparatus or the another image formation apparatus on the network, when a mode is set such that the image formation of the image data is carried out per set of sheets.

9. The image formation apparatus according to claim 2, further comprising a load distribution setting unit that sets determination of load distribution as to whether an image of the image data is to be formed by its own apparatus or the another image formation apparatus on the network,
wherein the determining unit determines whether the image of the image data is formed by its own apparatus or the another image formation apparatus on the network based on the detected property of the image data and the state of the apparatus detected by the apparatus state detecting unit, when the load distribution setting unit sets that the determination of the load distribution is carried out.

10. An image formation method comprising the steps of:
detecting a property of image data;
determining whether an image of the image data is to be formed by its own apparatus or another image formation apparatus on a network, based on the property of the image data detected at the step of detecting the property;
forming an image to be output from the image data, when it is determined at the determining step that the image is to be formed by its own apparatus; and
transmitting the image data to the another image formation apparatus, when it is determined at the determining step that the image is to be formed by the another image formation apparatus.

11. The image formation method according to claim 10, further comprising the step of detecting a state of the image formation apparatus,
wherein at the determining step, it is determined whether an image of the image data is to be formed by its own apparatus or the another image formation apparatus on the network, based on the detected property of the image data and the state of the image formation apparatus detected at the step of detecting the state.

12. The image formation method according to claim 11, wherein at the step of detecting the state, a state of the another image formation apparatus connected to the network is detected.

13. The image formation method according to claim 10,
wherein at the step of detecting the state, it is detected whether the image data is monochrome data or color data, and
at the determining step, it is determined that an image of the image data is to be formed by the another image formation apparatus on the network, when the detected property of the image data is color and its own apparatus is designed specifically for the monochrome data.

14. The image formation method according to claim 11,
wherein at the step of detecting the state, a residual amount of toner is detected, and
at the determining step, it is determined that an image of the image data is to be formed by the another image formation apparatus on the network, when the residual amount of toner detected at the step of detecting the state is smaller than a predetermined value.

15. The image formation method according to claim 11,
wherein at the determining step, it is determined, for each of pages of the image data, whether an image of the image data is to be formed by its own apparatus or the another image formation apparatus on the network, based on the detected property of the image data and the state of the apparatus detected at the step of detecting the state,
at the step of forming the image, an image to be output is formed from the image data with respect to the page determined to be formed by its own apparatus at the determining step, and
at the transmitting step, image data for the page determined to be formed by the another image formation apparatus at the determining step is transmitted to the another image formation apparatus.

16. The image formation method according to claim 15,
wherein at the determining step, it is determined whether an image of the image data is to be formed by its own apparatus or the another image formation apparatus on the network, with respect to all of the pages of the image data, when a predetermined setting is carried out with respect to the image formation of the image data.

17. The image formation method according to claim 16,
wherein at the determining step, it is determined whether an image of the image data is to be formed by its own apparatus or the another image formation apparatus on the network, with respect to all of the pages of the image data, when a mode is set such that the image formation of the image data is carried out per set of sheets.

18. The image formation method according to claim 11, further comprising the step of setting determination of load distribution as to whether an image of the image data is to be formed by its own apparatus or the another image formation on the network,
wherein at the determining step, it is determined whether an image of the image data is to be formed by its own apparatus or the another image formation apparatus on the network, based on the detected property of the image data and the detected state of the apparatus, when at the load distribution setting step, it is set that the determination of the load distribution is carried out.
